(19) United States
(12) Patent Application Publication
(10) Pub. No.: US 2018/0023543 A1
(43) Pub. Date: Jan. 25, 2018

(54) A WIND TURBINE COMPRISING TWO OR MORE ROTORS

(71) Applicant: Vestas Wind Systems A/S, Aarhus N. (DK)

(72) Inventors: Henrik Kudsk, Harlev J (DK); Torben Ladegaard Baun, Skødstrup (DK); Erik Carl Lehnskov Miranda, Randers Sv (DK); Etekamba Okon Willie, Tilst (DK)

(21) Appl. No.: 15/552,359

(22) PCT Filed: Mar. 17, 2016
(86) PCT No.: PCT/DK2016/050076

§ 371 Date: Aug. 21, 2017

(30) Foreign Application Priority Data
Mar. 30, 2015 (DK) PA 2015 70186

(51) Int. Cl. F03D 1/02; F03D 9/25; F16H 7/02; F03D 15/00; F03D 80/80; F03D 7/02; F03D 13/20

(52) U.S. Cl. CPC F03D 1/02; F03D 7/0204; F03D 9/25; F03D 13/20; F03D 15/00; F03D 80/82; F16H 7/02; F05B 2260/4021

(57) ABSTRACT

A multirotor wind turbine (1) comprising a tower structure with a main tower part (2) and at least two arms (3), each arm (3) extending away from the main tower part (2) along a direction having a horizontal component. Two or more rotors (4) are mounted on the tower structure in such a manner that each arm (3) of the tower structure carries at least one rotor (4). A gear arrangement (9) of at least one of the rotors (4) comprises a number of pulleys (10, 11, 13) and a number of belts (16, 17) interconnecting the pulleys (10, 11, 13) in order to transfer rotational movements between the pulleys (10, 11, 13), thereby transferring rotational movements from the hub (5) to a rotating shaft (14) connected to a generator (15).

### FIELD OF THE INVENTION

The present invention relates to a multirotor wind turbine, i.e. to a wind turbine comprising two or more rotors.

### BACKGROUND OF THE INVENTION

Wind turbines normally comprise at least one rotor comprising a hub carrying a set of wind turbine blades. The wind turbine blades catch the wind, thereby causing the hub to rotate. The rotational movements of the hub are then transferred to a generator, either via a gear arrangement or directly, in the case that the wind turbine is of a so-called direct drive type. In the generator the mechanical energy of the rotational movements is transformed into electrical energy, which may subsequently be supplied to a power grid.

Some wind turbines are provided with two or more rotors in order to increase the total power produced by the wind turbine, without having to provide the wind turbine with one very large, and therefore heavy, rotor. Wind turbines comprising two or more rotors are, e.g., disclosed in WO 2010/098813 and in GB 2 443 886.

Even though the wind turbine designs disclosed in WO 2010/098813 and in GB 2 443 886 result in reduced loads on various parts of the wind turbine, as compared to a single rotor wind turbine generating a similar power level, it is still desirable to further reduce the weight of the rotors, and to thereby further reduce the loads on various parts of the wind turbine, such as the tower structure, the hubs, the bearings, etc.

### DESCRIPTION OF THE INVENTION

It is an object of embodiments of the invention to provide a multirotor wind turbine in which the loads on various parts of the turbine are reduced as compared to prior art multirotor wind turbines.

It is a further object of embodiments of the invention to provide a multirotor wind turbine in which the total weight of each rotor is reduced as compared to prior art multirotor wind turbines.

The invention provides a wind turbine comprising:
a tower structure comprising a main tower part being anchored, at a lower part, to a foundation structure, the main tower part extending along a substantially vertical direction, the tower structure further comprising at least two arms, each arm extending away from the main tower part along a direction having a horizontal component, and
two or more rotors mounted on the tower structure in such a manner that each arm of the tower structure carries at least one rotor, each rotor comprising a hub carrying a set of wind turbine blades, the hub being mounted rotatably on the tower structure; a rotating shaft arranged to be connected to a generator in order to transfer rotational movements to the generator; and a gear arrangement arranged to transfer rotational movements of the hub to rotational movements of the rotating shaft,

wherein the gear arrangement of at least one of the rotors comprises a number of pulleys and a number of belts interconnecting the pulleys in order to transfer rotational movements between the pulleys, thereby transferring rotational movements from the hub to the rotating shaft.

The wind turbine according to the invention comprises a tower structure. The tower structure comprises a main tower part and at least two arms.

The main tower part is anchored, at a lower part, to a foundation structure. Furthermore, the main tower part extends along a substantially vertical direction. Thus, the main tower part resembles a traditional wind turbine tower for a single rotor wind turbine.

Each of the arms of the tower structure extends away from the main tower part along a direction having a horizontal component. The arms may extend away from the main tower part along a substantially horizontal direction. In this case the arms extend substantially perpendicularly to the vertically arranged main tower part. As an alternative, the arms may extend away from the main tower part along a direction which has a horizontal component as well as a vertical component. In this case the arms extend away from the main tower part at an angle with respect to the main tower part which differs from 90°. The angle defined between the arms and the main tower part may advantageously be between 45° and 90°.

In any event, since the arms of the tower structure extend away from the main tower part along a direction having a horizontal component, they do not extend parallel to the vertical main tower part, but instead at an angle with respect to the main tower part.

The arms may be in the form of trusses, beams, systems of beams, lattice structures, etc. Furthermore, the arms may not necessarily be linear structures, but they may have a rounded or curved shape.

Thus, the tower structure comprises a substantially vertical main part, and at least two arms extending therefrom in a non-vertical direction.

The wind turbine further comprises at least two rotors mounted on the tower structure. Accordingly, the wind turbine is a multirotor wind turbine. The rotors are mounted on the tower structure in such a manner that each arm of the tower structure carries at least one rotor. Accordingly, the loads arising from the weight of at least some of the rotors is applied to the arms of the tower structure, and transferred to the main tower part, via the arms.

It is not ruled out that one or more of the rotors are mounted directly on or carried by the main tower part, as long as at least some of the rotors are carried by the arms of the tower structure.

Each rotor comprises a hub carrying a set of wind turbine blades, a rotating shaft arranged to be connected to a generator, and a gear arrangement arranged to transfer rotational movements of the hub to rotational movements of the rotating shaft. The hub is rotatably mounted on the tower structure, such as on an arm of the tower structure. Thereby the hub can rotate when the wind turbine blades catch the wind, as described above. The rotating movements of the hub are then transferred to the rotating shaft, via the gear arrangement, and further on to the generator, where electrical power is generated.

The gear arrangement of at least one of the rotors comprises a number of pulleys and a number of belts interconnecting the pulleys in order to transfer rotational movements between the pulleys, i.e. rotational movements are transferred between the pulleys by means of the belts. Thereby the rotational movements of the hub are transferred to rotational movements of the rotating shaft by means of the interconnected pulleys and belts.

In the present context the term ‘pulley’ should be interpreted to mean a relatively flat object, having a substantially circular shape. In the present context the term ‘belt’ should be interpreted to mean an endless structure, forming a flexible ring.

Thus, the gear arrangement of at least one of the rotors is in the form of a belt drive. This is an advantage, since the weight of a belt drive is typically significantly lower than the weight of a corresponding gear arrangement using intermeshing toothed gear wheels. Thereby the weight to be carried by the arms of the tower structure can be reduced. As a consequence, the loads on various parts of the wind turbine can be reduced. For instance, loads on the tower structure, in particular on the arms of the tower structure, are reduced. Furthermore, loads on the hubs and bearings are reduced.

The reduction of the loads, due to the decreased weight of the gear arrangement, allows the amount of material used for various parts of the wind turbine, in particular the tower, to be reduced, thereby even further decreasing the total weight of the wind turbine. This is an advantage, because it makes transport of the wind turbine easier, and because the total manufacturing costs of the wind turbine are reduced. It is in particular an advantage, that the weight to be carried by the arms is reduced, thereby reducing the loads on the arms. Previously, wind turbines comprising two or more rotors have been considered a too expensive solution for some applications, because the costs involved with providing the arms have been too high, because the arms had to be designed to carry the heavy loads. By providing the rotors with belt drives instead of traditional gear arrangements, the weight, and thereby the loads, carried by the arms may be reduced, and accordingly the problems relating to the costs of providing the arms may be solved.

The gear arrangement of each of the rotors may comprise a number of pulleys and a number of belts interconnecting the pulleys in order to transfer rotational movements between the pulleys, thereby transferring rotational movements from the hub to the rotating shaft. According to this embodiment, all of the rotors comprise a gear arrangement in the form of a belt drive. As an alternative, some of the rotors may comprises a gear arrangement in the form of a belt drive, and some of the rotors may comprise another type of gear arrangement, such as a gear arrangement using intermeshing toothed gear wheels.

At least two of the arms of the tower structure may form part of a single transverse structure. The single transverse structure could, e.g., be in the form of a single beam mounted on or being integral with the main tower part, and extending away from the main tower part in two directions. The two directions may advantageously be opposite in the sense that they are arranged with an angle of 180° there between when seen from above. This allows forces acting on one arm to be balanced by forces acting on the other arm. Furthermore, it allows a rotor carried by one of the arms as well as a rotor carried by the other arm to be directed towards the wind simultaneously.

As an alternative, each of the arms of the tower structure may form an individual part, which is mounted on the main tower part.

At least two of the arms of the tower structure may be arranged substantially symmetrically with respect to the main tower part. This may, e.g., include that the arms appear to extend away from the main tower part in substantially opposite directions, when seen from above. The arms may extend away from the main tower part along substantially opposite, substantially horizontal directions. As an alternative, the arms may extend away from the main tower part at an angle with respect to the main tower part, which differs from 90°, but the angle defined between the main tower part and a first arm is substantially equal to the angle defined between the main tower part and a second arm.

At least one of the arms of the tower structure may extend away from the main tower part along a substantially horizontal direction. As described above, in this case the arm(s) extend(s) in a direction which is substantially perpendicular to the vertical direction of the main tower part. As described above, one or more of the arms may alternatively extend away from the main tower part along a direction which defines an angle with respect to the main tower part, which differs from 90°, such as between 45° and 90°.

The gear arrangement of at least one of the rotors may comprise:
a primary pulley being rotationally decoupled from the hub,
two or more planetary pulleys, each planetary pulley being mounted on the hub, thereby rotating along with the hub, and each planetary pulley being provided with a planetary shaft, each planetary pulley being arranged to perform rotational movements about its planetary shaft, and
a centre pulley being connected to the rotating shaft,

and at least one belt may interconnect the primary pulley to each of the planetary shafts, and at least one belt may interconnect each of the planetary pulleys to the centre pulley.

According to this embodiment, the pulleys of the gear arrangement are mounted in a planetary manner with a primary pulley, two or more planetary pulleys and a centre pulley. The primary pulley is rotationally decoupled from the hub, i.e. the primary pulley does not rotate along with the hub when the wind acts on the wind turbine blades. The primary pulley may be fixedly mounted relative to the tower structure, in particular relative to an arm of the tower structure which carries the rotor. As an alternative, the primary pulley may be arranged to perform rotational movements relative to the tower structure, as long as these rotational movements are not following the rotational movements of the hub. Accordingly, when the hub rotates, a relative movement occurs between the hub and the primary pulley.

Each of the planetary pulleys is mounted on the hub, i.e. the planetary pulleys rotate along with the hub when the hub rotates due to the wind acting on the wind turbine blades. Thereby a relative rotational movement between the primary pulley and the planetary pulleys is also provided, when the hub rotates.

Each of the planetary pulleys is further provided with a planetary shaft, and each planetary pulley is arranged to perform rotational movements about its planetary shaft. Thus, apart from rotating along with the hub, each planetary pulley is also capable of performing individual rotational movements about the corresponding planetary shaft.

The centre pulley is connected to the rotating shaft. Thereby rotational movement of the centre pulley are directly transferred to the rotating shaft.

At least one belt interconnects the primary pulley to each of the planetary shafts. Thereby the relative rotational movement between the primary pulley and the planetary pulleys drives rotational movements of each of the planetary pulleys about their respective planetary shafts, via the at least one belt. One belt may interconnect the primary pulley and a given planetary shaft. In this case the belts of the respective planetary shafts may be arranged side by side on the primary pulley. As an alternative, the primary pulley and a given planetary shaft may be interconnected by two or more belts, the belts being arranged side by side on the primary pulley, as well as on the planetary shaft.

Furthermore, at least one belt interconnects each of the planetary pulleys to the centre pulley. Thereby the rotational movements of the planetary pulleys, about their respective planetary shafts, drives a rotational movement of the centre pulley, and thereby of the rotating shaft, via the at least one belt. As described above, a single belt or two or more belts arranged side by side may be applied.

At least one of the rotors may comprise a hollow king pin. In this case the hub of the relevant rotor(s) may be rotationally mounted on the corresponding king pin via a main bearing arrangement. In this case the main bearing arrangement may comprise a single bearing, or it may comprise two or more bearings arranged along an axial direction defined by the king pin. The king pin may extend through the hub and be fixedly mounted relative to the tower structure, in particular relative to an arm of the tower structure which carries the rotor.

The hub of at least one of the rotors may be arranged between the gear arrangement and a mounting position of the rotor on the tower structure. According to this embodiment, the gear arrangement, the hub and the mounting position of the rotor on the tower structure are arranged relative to each other in such a manner that, seen in a direction from the tower structure, the hub is first encountered, and subsequently the gear arrangement. Accordingly, the gear arrangement may be regarded as being arranged in front of the hub. Furthermore, the gear arrangement and the mounting position of the rotor on the tower structure may be regarded as being positioned at opposing sides of the hub, along an axial direction. This allows the belts of the gear arrangement to be easily inspected and replaced, because they are readily accessible. For instance, the belts of the gear arrangement can be replaced without dismantling either the generator or the hub.

As an alternative, the relative positions of the gear arrangement, the hub and the mounting position of the rotor on the tower structure may differ from the one described above. For instance, the gear arrangement may be arranged between the hub and the mounting position of the rotor on the tower structure, or the mounting position of the rotor on the tower structure may be arranged between the hub and the gear arrangement.

As another alternative, the primary pulley may be arranged to rotate along with the hub, and the planetary pulleys may be decoupled from the hub, as long as the rotation of the hub results in relative rotational movements of the primary pulley and the planetary pulleys.

Each of the rotors may be connected to a separate generator. According to this embodiment, the wind turbine comprises one dedicated generator for each of the rotors, the rotating shaft of each of the rotors is connected to one generator, and each generator is connected to the rotating shaft of one rotor. The generators may, in this case, be arranged adjacent to the respective rotors.

As an alternative, the wind turbine may comprise a single generator, which is connected to the rotating shafts of all of the rotors, e.g. via one or more belts. As another alternative, the wind turbine may comprise two or more generators, at least one of the generators being connected to the rotating shafts of two or more rotors, i.e. the number of generators is lower than the number of rotors.

The wind turbine may further comprise a yawing mechanism, said yawing mechanism being operated by controlling aerodynamic thrust forces of the rotors. For instance, the alignment of the rotors with the wind may be controlled by regulating the thrust of a first rotor with respect to a second rotor arranged on an opposite side of the main tower part, e.g. by use of a blade pitch control.

The wind turbine may further comprise one or more control components and/or one or more transformers being arranged inside the tower structure. The control component(s) could, e.g., include one or more controllers, one or more converters, etc. The control component(s) and/or transformer(s) may be arranged inside the arms of the tower structures. Alternatively it/they may be arranged inside the main tower part, e.g. at a position where an arm is mounted on the main tower part. Thereby the control component(s) and/or the transformer(s) will be arranged close to the rotors carried by the arms of the tower structure. As another alternative, the control component(s) and/or the transformer(s) may be arranged at a lower part of the main tower part.

Alternatively or additionally, the wind turbine may further comprise one or more control components and/or one or more transformers being arranged inside a container positioned adjacent to a lower part of the main tower part. Thereby the weight to be carried by the arms of the tower structure is even further reduced, and the weight is, in particular, moved away from the tips of the arms. This even further reduces the loads to be carried by the arms of the tower structure.

### BRIEF DESCRIPTION OF THE DRAWINGS

The invention will now be described in further detail with reference to the accompanying drawings in which

FIG. 1 is a front view of a wind turbine according to an embodiment of the invention,

FIG. 2 is a top view of the wind turbine of FIG. 1,

FIG. 3 is a cross sectional view of a rotor for a wind turbine according to an embodiment of the invention,

FIG. 4 is a front view of the gear arrangement of the rotor of FIG. 3, and

FIG. 5 is a front view of a wind turbine according to an alternative embodiment of the invention.

### DETAILED DESCRIPTION OF THE DRAWINGS

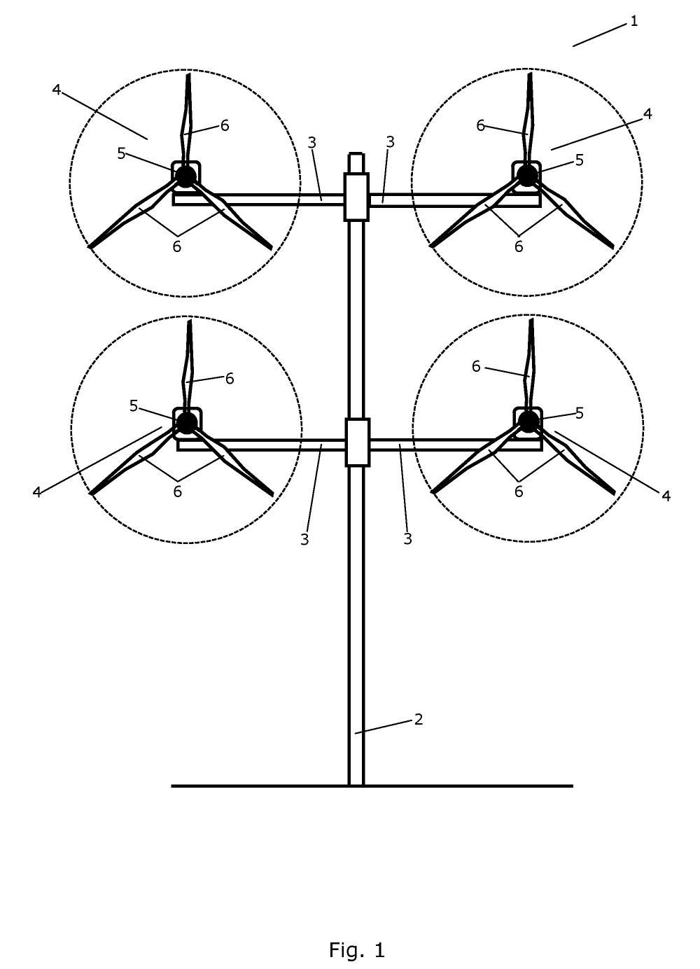

FIG. 1 is a front view of a wind turbine 1 according to an embodiment of the invention. The wind turbine 1 comprises a tower structure with a main tower part 2, extending along a substantially vertical direction, and four arms 3 extending away from the main tower part 2 along substantially horizontal directions.

Each of the arms 3 carries a rotor 4. Each rotor comprises a hub 5 carrying a set of wind turbine blades 6. The hubs 5 are mounted rotatably on the respective arms 3, thereby allowing the wind to cause the hubs 5 to rotate by acting on the wind turbine blades 6. The rotational movements of the hubs 5 are transferred to one or more generators (not shown), via gear arrangements (not shown) of the rotors 4, in a manner which will be described in further detail below.

The four arms 3 are arranged in such a manner that two of them are mounted on the main tower part 2 at a first height, and the other two are mounted on the main tower part 2 at a second, higher height. Two arms 3 mounted on the main tower part 2 at the same height extend away from the main tower part 2 along substantially opposite directions. Accordingly, the arms 3 are arranged symmetrically with respect to the main tower part 2. Thereby the loads introduced in the tower structure by the arms 3, including the loads introduced by the weight of the rotors 4 carried by the arms 3, are balanced.

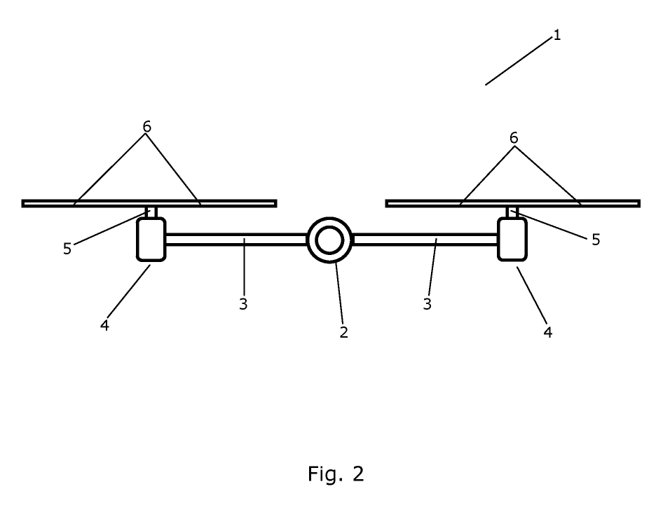

FIG. 2 is a top view of the wind turbine 1 of FIG. 1, showing two of the rotors 4. It is clear from FIG. 2 that the arms 3 extend from the main tower part 2 along substantially opposite directions.

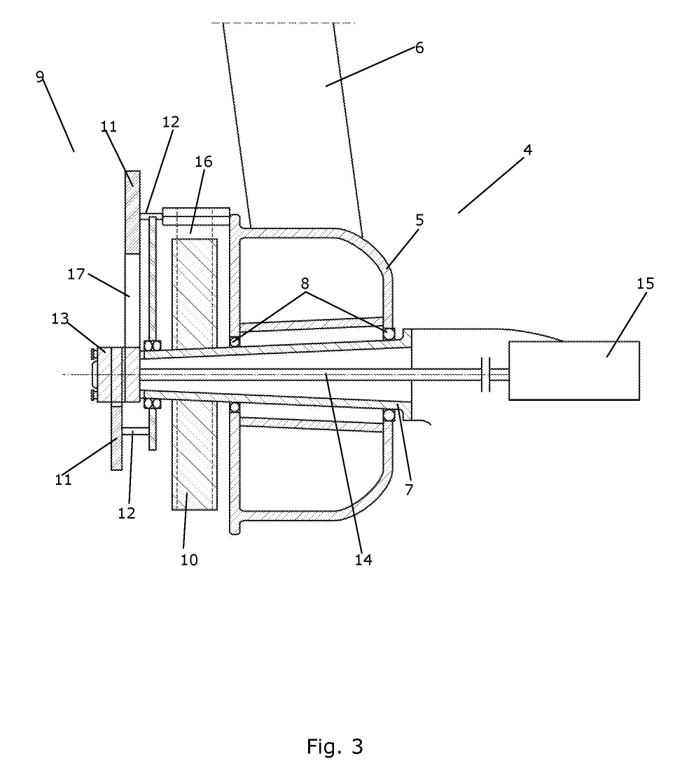

FIG. 3 is a cross sectional view of a rotor 4 for a wind turbine according to an embodiment of the invention. The rotor 4 could, e.g., be one of the rotors 4 of the wind turbine of FIGS. 1 and 2. The rotor 4 comprises a hub 5, carrying a number of wind turbine blades 6, one of which is shown.

The hub 5 is mounted rotatably on a hollow king pin 7 via two bearings 8 constituting a main bearing arrangement. Accordingly, wind acting on the wind turbine blades 6, carried by the hub 5, causes the hub 5 to rotate relative to the hollow king pin 7 about a substantially horizontal axis.

The rotor 4 further comprises a gear arrangement 9 mounted in front of the hub 5 along a direction facing the wind. It should, however, be noted that, in an alternative embodiment, the gear arrangement 9 could be arranged behind the hub 5 along a direction facing the wind, such as between the hub 5 and a mounting position of the rotor 4 on the tower structure.

The gear arrangement 9 comprises a primary pulley 10, three planetary pulleys 11, each being provided with a planetary shaft 12, and a centre pulley 13. The centre pulley 13 is connected to a rotating shaft 14 which extends through the hollow king pin 7, and which is arranged to transfer rotational movements from the centre pulley 13 to a generator 15.

The primary pulley 10 is mounted fixedly on the hollow king pin 7, and the planetary pulleys 11 are mounted on the hub 5. Furthermore, the primary pulley 10 is connected to each of the planetary shafts 12 via a belt 16, which encircles the primary pulley 10 and each of the planetary shafts 12, and the three planetary pulleys 11 are connected to the centre pulley 13 via three belts 17, which each encircles one of the planetary pulleys 11 and the centre pulley 13. Thus, when the hub 5 rotates, a relative rotational movement between the primary pulley 10 on the one hand, and the planetary pulleys 11 and the planetary shafts 12 on the other hand, is introduced. Due to the belt connection, via belt 16, between the primary pulley 10 and the planetary pulleys 11 and shafts 12, this will cause each of the planetary shafts 12 to be rotated, and thereby each of the planetary pulleys 11 will perform a rotational movement about its planetary shaft 12.

Due to the belt connections, via belts 17, between each of the planetary pulleys 11 and the centre pulley 13, the rotational movements of the planetary pulleys 11 described above will cause the centre pulley 13, and thereby the rotating shaft 14, to rotate. Accordingly, rotational movements are transferred from the hub 5 to the generator 15, via the gear arrangement 9 and the rotating shaft 14.

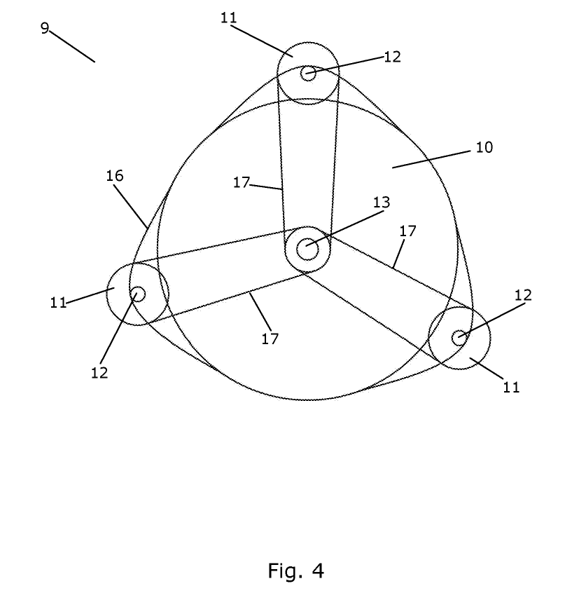

FIG. 4 is a front view of the gear arrangement 9 of the rotor 4 of FIG. 3. It can be seen how the belt 16 encircles the primary pulley 10 and each of the planetary shafts 12, and how the belts 17 each encircles one of the planetary pulleys 11 and the centre pulley 13.

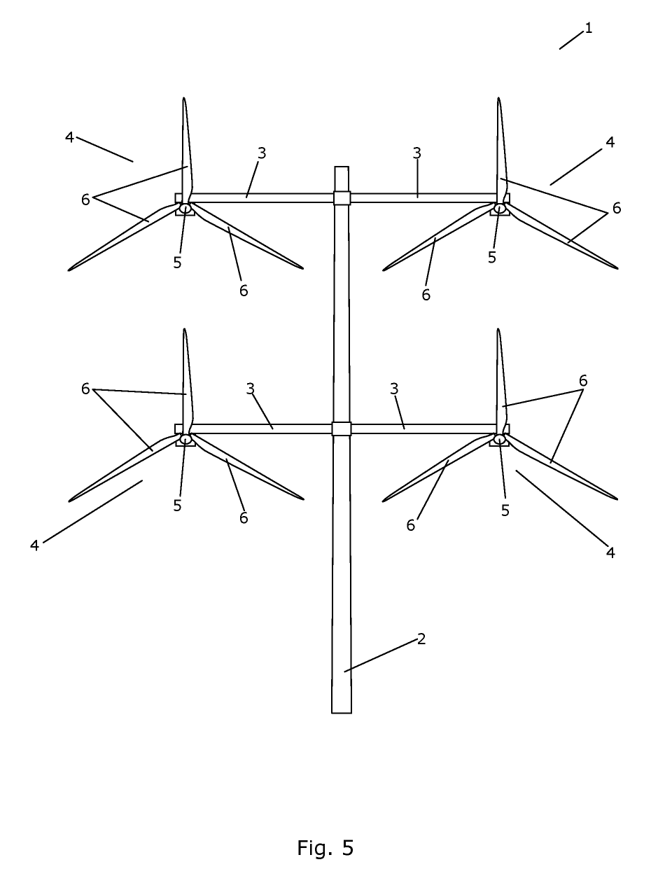

FIG. 5 is a front view of a wind turbine 1 according to an alternative embodiment of the invention. The wind turbine 1 of FIG. 5 is very similar to the wind turbine 1 of FIG. 1, and it will therefore not be described in detail here.

In the wind turbine 1 of FIG. 5 the rotors 4 are mounted on a lower side of the respective arms 3. This allows the rotors 4 to be readily hoisted into position on the arm 3 of the tower structure, or lowered to the ground, without the need for large cranes or the like. Thereby erecting the wind turbine 1, decommissioning the wind turbine 1 and/or replacing a rotor 4 is very easy and cost effective.

The arms 3 may be mounted on the main tower part 2 in a pivotal or rotational manner, allowing the upper and lower arms 3 to be rotated relative to each other, thereby allowing the rotors 4 mounted on the upper arms 3 to be moved away from a position directly above the rotors 4 being mounted on the lower arms 3. This will allow the rotors 4 mounted on the upper arms 3 to be lowered to the ground without colliding with the rotors 4 mounted on the lower arms 3.

1. A wind turbine comprising:
a tower structure comprising a main tower part being anchored, at a lower part, to a foundation structure, the main tower part extending along a substantially vertical direction, the tower structure further comprising at least two arms, each arm extending away from the main tower part along a direction having a horizontal component, and
two or more rotors mounted on the tower structure in such a manner that each arm of the tower structure carries at least one rotor, each rotor comprising a hub carrying a set of wind turbine blades, the hub being mounted rotatably on the tower structure; a rotating shaft arranged to be connected to a generator in order to transfer rotational movements to the generator; and a gear arrangement arranged to transfer rotational movements of the hub to rotational movements of the rotating shaft,
wherein the gear arrangement of at least one of the rotors comprises a number of pulleys and a number of belts interconnecting the pulleys in order to transfer rotational movements between the pulleys, thereby transferring rotational movements from the hub to the rotating shaft.

2. The wind turbine according to claim 1, wherein the gear arrangement of each of the rotors comprises a number of pulleys and a number of belts interconnecting the pulleys in order to transfer rotational movements between the pulleys, thereby transferring rotational movements from the hub to the rotating shaft.

3. The wind turbine according to claim 1, wherein at least two of the arms of the tower structure form part of a single transverse structure.

4. The wind turbine according to claim 1, wherein at least two of the arms of the tower structure are arranged substantially symmetrically with respect to the main tower part.

5. The wind turbine according to claim 1, wherein at least one of the arms of the tower structure extends away from the main tower part along a substantially horizontal direction.

6. The wind turbine according to claim 1, wherein the gear arrangement of at least one of the rotors comprises:
a primary pulley being rotationally decoupled from the hub,
two or more planetary pulleys, each planetary pulley being mounted on the hub, thereby rotating along with the hub, and each planetary pulley being provided with a planetary shaft, each planetary pulley being arranged to perform rotational movements about its planetary shaft, and
a centre pulley being connected to the rotating shaft, wherein at least one belt interconnects the primary pulley to each of the planetary shafts, and at least one belt interconnects each of the planetary pulleys to the centre pulley.

7. The wind turbine according to claim 1, wherein at least one of the rotors comprises a hollow king pin.

8. The wind turbine according to claim 1, wherein the hub of at least one of the rotors is arranged between the gear arrangement and a mounting position of the rotor on the tower structure.

9. The wind turbine according to claim 1, wherein each of the rotors is connected to a separate generator.

10. The wind turbine according to claim 1, further comprising a yawing mechanism, said yawing mechanism being operated by controlling aerodynamic thrust forces of the rotors.

11. The wind turbine according to claim 1, further comprising one or more control components and/or one or more transformers being arranged inside the tower structure.

12. The wind turbine according to claim 1, further comprising one or more control components and/or one or more transformers being arranged inside a container positioned adjacent to a lower part of the main tower part.
